(19) United States
(12) Patent Application Publication
(10) Pub. No.: US 2017/0289522 A1
(43) Pub. Date: Oct. 5, 2017

(54) LIGHT-FIELD CAMERA AND CONTROLLING METHOD

(71) Applicants: Fu Tai Hua Industry (Shenzhen) Co., Ltd., Shenzhen (CN); HON HAI PRECISION INDUSTRY CO., LTD., New Taipei (TW)

(72) Inventor: XUE-QIN ZHANG, Shenzhen (CN)

(21) Appl. No.: 15/472,292

(22) Filed: Mar. 29, 2017

(30) Foreign Application Priority Data
Apr. 5, 2016 (CN) 201610206095.1

(51) Int. Cl. H04N 13/02; G06K 9/62; G06K 9/78; H04N 5/265

(52) U.S. Cl. CPC H04N 13/0207; H04N 5/265; G06K 9/6201; H04N 13/0296; G06K 9/78

(57) ABSTRACT

A method for controlling a light-field camera device includes controlling the light-field camera to capture a plurality of images. Situational measurements or markers of the light-field camera are recorded when the light-field camera captures each of the plurality of images, the plurality of images are composed into a three-dimensional image for composing and capturing a desired image.

### CROSS-REFERENCE TO RELATED APPLICATIONS

This application claims priority to Chinese Patent Application No. 201610206095.1 filed on Apr. 5, 2016, the contents of which are incorporated by reference herein.

### FIELD

The subject matter herein generally relates to a camera controlling technology, and particularly to a light-field camera and a method for controlling the light-field camera.

### BACKGROUND

When a light-field camera locates a target object, the light-field camera needs to first capture an image of the target object. The target object in the captured image is then marked to enable a positioning of the target object in the captured image, to correspond to an actual position of the target object. This locating method costs time.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a block diagram of one exemplary embodiment of a light-field camera including a controlling system.

FIG. 2 illustrates a flowchart of one exemplary embodiment of a method for controlling the light-field camera of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, JAVA, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

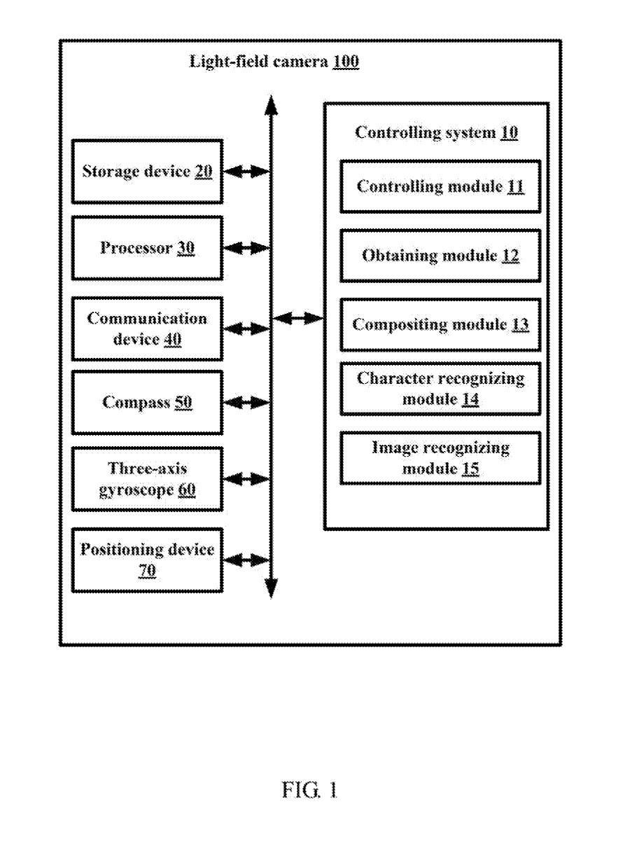

FIG. 1 is a block diagram of one exemplary embodiment of a light-field camera 100 including a controlling system 10. Depending on the embodiment, the light-field camera 100 can include, but is not limited to, a storage device 20, at least one processor 30, a communication device 40, a compass 50, a three-axis gyroscope 60, and a positioning device 70. The light-field camera 100 can be used to capture images of a scene or an object. For example, the light-field camera 100 can capture images of objects in a supermarket, in a manufacturing shop, in a park, or in a warehouse.

The storage device 20 can be used to store all kinds of data of the light-field camera 100. For example, the storage device 20 can be used to store images captured by the light-field camera 100. In at least one exemplary embodiment, the storage device 20 can be an internal storage device, such as a flash memory, a random access memory (RAM) for temporary storage of information, and/or a read-only memory (ROM) for permanent storage of information. The storage device 20 can also be an external storage device, such as an external hard disk, a storage card, or a data storage medium.

The at least one processor 30 can communicate with the storage device 20, the communication device 40, the compass 50, the three-axis gyroscope 60, and the positioning device 70. The at least one processor 30 can execute program codes and data stored in the storage device 20. The at least one processor 30 can be a central processing unit (CPU), a microprocessor, or other data processor chip that performs functions of the light-field camera 100. In at least one exemplary embodiment, the at least one processor 30 can be integrated in the light-field camera 100. In other exemplary embodiments, the at least one processor 30 can be externally connected with the light-field camera 100.

The communication device 40 enables the light-field camera 100 to communicate with other light-field cameras 100 and/or a remote server (not indicated in FIG. 1). In at least one exemplary embodiment, the communication device 40 can be a BLUETOOTH module, a WI-FI module, or a ZIGBEE module.

The compass 50 can be used to detect a capturing orientation of the light-field camera 100 when the light-field camera 100 captures an image. The three-axis gyroscope 60 can be used to detect a capturing angle of the light-field camera 100 when the light-field camera 100 captures the image. The positioning device 70 can be used to detect a capturing position of the light-field camera 100 when the light-field camera 100 captures the image. In at least one exemplary embodiment, the positioning device 70 can be a global positioning system (GPS) device. In other exemplary embodiments, the positioning device 70 can be an indoor positioning system (IPS) device, for example, the indoor positioning system of GOOGLE, NOKIA, BROADCOM, INDOORS ATLAS, OR QUBULUS. Depending on the embodiment, the compass 50 can be an electronic compass. The three-axis gyroscope 60 can be an electronic compass. The positioning device 70 can be the indoor positioning system.

In at least one exemplary embodiment, the controlling system 10 can include computerized instructions in the form of one or more programs that can be stored in the storage device 20 and executed by the at least one processor 30. In at least one exemplary embodiment, the controlling system 10 can be integrated with the at least one processor 30. In other exemplary embodiments, the controlling system 10 can be independent from the at least one processor 30. As illustrated in FIG. 1, the controlling system 10 can include one or more modules, for example, a controlling module 11, an obtaining module 12, a compositing module 13, a character recognizing module 14, and an image recognizing module 15.

The controlling module 11 can control the light-field camera 100 to capture an image by transmitting a capturing signal to the light-field camera 100. The controlling module 11 can detect situational markers (hereinafter “capturing parameters”) of the light-field camera 100 when the light-field camera 100 captures the image.

In at least one exemplary embodiment, the capturing parameters of the light-field camera 100 can include, but are not limited to, the capturing orientation of the light-field camera 100 when the light-field camera 100 captures the image, the capturing angle of the light-field camera 100 when the light-field camera 100 captures the image, the capturing position of the light-field camera 100 when the light-field camera 100 captures the image, and/or a combination thereof.

In at least one exemplary embodiment, the controlling module 11 can control the compass 50 to detect the capturing orientation of the light-field camera 100 when the light-field camera 100 captures the image, by transmitting a first control signal to the compass 500. The controlling module 11 can control the three-axis gyroscope 60 to detect the capturing angle of the light-field camera 100 when the light-field camera 100 captures the image, by transmitting a second control signal to the three-axis gyroscope 60. The controlling module 11 can control the positioning device 70 to detect the capturing position of the light-field camera 100 when the light-field camera 100 captures the image by transmitting a third control signal to the positioning device 70.

In at least one exemplary embodiment, the controlling module 11 can transmit the first control signal, the second control signal, the third control signal, and the capturing signal at a same time. In other exemplary embodiments, the controlling module 11 can transmit the first control signal, the second control signal, and third control signal immediately when the capturing signal is transmitted. In at least one exemplary embodiment, the controlling module 11 generates the capturing signal in response to a physical button of the light-field camera 100 being pressed.

Based on the above method, the controlling module 11 can control the light-field camera 100 to capture a number of images. The controlling module 11 can detect the capturing orientation, the capturing angle, and the capturing position of the light-field camera 100 when the light-field camera 100 captures each of the number of images.

The obtaining module 12 can obtain the number of images, and obtain the capturing parameters of the light-field camera 100 when the light-field camera 100 captures each of the number of images.

The compositing module 13 can composite the number of images to form a three-dimensional image according to the capturing parameters of the light-field camera 100 when the light-field camera 100 captures each of the number of images. In at least one exemplary embodiment, the capturing parameters of the light-field camera 100 when the light-field camera 100 captures each of the number of images are selected from the capturing orientation and the capturing angle of the light-field camera 100 when the light-field camera 100 captures each image. In other exemplary embodiments, the capturing parameters of the light-field camera 100 when the light-field camera 100 captures each of the number of images are selected from the capturing orientation, the capturing angle, and the capturing position of the light-field camera 100 when the light-field camera 100 captures each image. In at least one exemplary embodiment, the compositing module 13 can first composite the number of images to form a first three-dimensional image according to the capturing orientation and the capturing angle of the light-field camera 100 when the light-field camera 100 captures each image. The compositing module 13 can then mark the first three-dimensional image with the capturing position of the light-field camera 100 when the light-field camera 100 captures each image. In at least one exemplary embodiment, the three-dimensional image functions as a map such as providing a navigation function. That is, the three-dimensional image having the function of the map is not obtained by drawing, but obtained by compositing the number of images captured by the light-field camera 100 into a composite image.

The character recognizing module 14 can recognize characters from each of the number of images. The character recognizing module 14 can convert the characters recognized in each of the number of images into an individual editable text. The character recognizing module 14 can store the number of images and each individual editable text into the storage device 20. The character recognizing module 14 can establish a relationship between each individual editable text and the corresponding image. In at least one exemplary embodiment, the character recognizing module 14 can recognize characters using optical character recognition (OCR) technology. In at least one exemplary embodiment, when no characters can be recognized from the image, the character recognizing module 14 use a predetermined tag to indicate no editable text corresponding to the image. In at least one exemplary embodiment, the predetermined tag can be a word such as “EMPTY”. The character recognizing module 14 can further add the predetermined tag to an exchangeable image file format (Exif) of the image.

The image recognizing module 15 can determine whether any one of the number of images matches a specific image.

In at least one exemplary embodiment, the specific image can be an image downloaded from the internet, or an image that is input by a user. In at least one exemplary embodiment, when one of the number of images is determined to match the specific image, the image recognizing module 15 can obtain the one of number of images from the storage device 20. The image recognizing module 15 can further display the one of the number of images on the light-field camera 100.

In at least one exemplary embodiment, when an object included in the one of the number of images matches an object included in the specific image, the image recognizing module 15 determines the one of the number of images matches the specific image. In at least one exemplary embodiment, the image recognizing module 15 can determine whether the object included in the one of the number of images matches the object included in the specific image using a scale scale-invariant feature transform (SIFT) algorithm, or a speed-up robust features (SURF) algorithm. In other exemplary embodiments, when the object included in the one of the number of images matches the object included in the specific image, and characters included in the one of the number of images matches the characters included in the specific image, the image recognizing module 15 can determine the one of the number of images matches the specific image.

When one of the number of images matches the specific image, the image recognizing module 15 can determine a position of the specific image in the three-dimensional image according to a capturing position of the specific image. The image recognizing module 15 can further mark the position of the specific image in the three-dimensional image.

In other exemplary embodiments, when the capturing position of one of the number of images matches the capturing position of the specific image, the image recognizing module 15 can determine that the one of the number of images matches the specific image. In at least one exemplary embodiment, when a distance between the capturing position of the specific image and the capturing position of the one of the number of images is less than a predetermined distance value (e.g., 0.2 meter), the image recognizing module 15 can determine that the capturing position of the one of the number of images matches the capturing position of the specific image. The image recognizing module 15 can further mark the capturing position of the specific image in the three-dimensional image.

The controlling module 11 can further control the communication device 40 to send the number of images captured by the light-field camera 100 to other light-field cameras or to a remote server (not indicated in FIG. 1). In at least one exemplary embodiment, a number of light-field cameras 100 can communicate with the remote server. Each of the number of light-field cameras 100 can transmit images captured by itself and transmit capturing parameters of each image to the remote server. The remote server 1 can composite the images transmitted from the number of light-field cameras 100 to form a three-dimensional image according to the capturing parameters of each image.

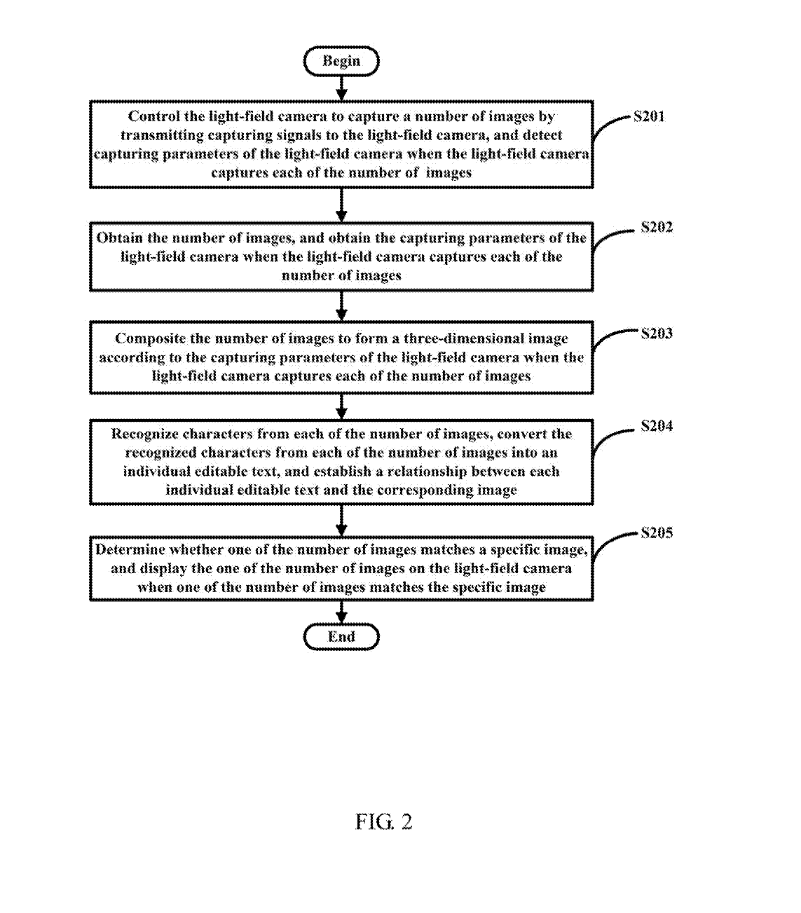

FIG. 2 illustrates a flowchart of one exemplary embodiment of a method of capturing an image. The exemplary method 200 is provided merely as an example, as there are a variety of ways to carry out the method. The method 200 described below can be carried out using the configurations illustrated in FIG. 1, for example, and various elements of these figures are referenced in explaining exemplary method 200. Each block shown in FIG. 2 represents one or more processes, methods, or subroutines, carried out in the exemplary method 200. Additionally, the illustrated order of blocks is by example only and the order of the blocks can be changed according to the present disclosure. The exemplary method 200 can begin at block S21. Depending on the embodiment, additional steps can be added, others removed, and the ordering of the steps can be changed.

At block S201, the controlling module 11 can control the light-field camera 100 to capture a number of images by transmitting capturing signals to the light-field camera 100. The controlling module 11 can detect capturing parameters of the light-field camera 100 when the light-field camera 100 captures each of the number of images.

In at least one exemplary embodiment, the capturing parameters of the light-field camera 100 can include, but are not limited to, the capturing orientation of the light-field camera 100 when the light-field camera 100 captures the image, the capturing angle of the light-field camera 100 when the light-field camera 100 captures the image, the capturing position of the light-field camera 100 when the light-field camera 100 captures the image, and/or a combination thereof.

The controlling module 11 can control the compass 50 to detect the capturing orientation of the light-field camera 100 when the light-field camera 100 captures an image by transmitting a first control signal to the compass 500. The controlling module 11 can control the three-axis gyroscope 60 to detect the capturing angle of the light-field camera 100 when the light-field camera 100 captures the image by transmitting a second control signal to the three-axis gyroscope 60. The controlling module 11 can control the positioning device 70 to detect the capturing position of the light-field camera 100 when the light-field camera 100 captures the image by transmitting a third control signal to the positioning device 70.

In at least one exemplary embodiment, the controlling module 11 can transmit the first control signal, the second control signal, the third control signal, and the capturing signal at a same time. In other exemplary embodiments, the controlling module 11 can transmit the first control signal, the second control signal, and third control signal immediately when the capturing signal is transmitted. In at least one exemplary embodiment, the controlling module 11 generates the capturing signal in response to a physical button of the light-field camera 100 is pressed.

At block S202, the obtaining module 12 can obtain the number of images, and obtain the capturing parameters of the light-field camera 100 when the light-field camera 100 captures each of the number of images.

At block S203, the compositing module 13 can composite the number of images to form a three-dimensional image according to the capturing parameters of the light-field camera 100 when the light-field camera 100 captures each of the number of images.

In at least one exemplary embodiment, the capturing parameters of the light-field camera 100 when the light-field camera 100 captures each of the number of images are selected from the capturing orientation and the capturing angle of the light-field camera 100 when the light-field camera 100 captures each image. In other exemplary embodiments, the capturing parameters of the light-field camera 100 when the light-field camera 100 captures each of the number of images are selected from the capturing orientation, the capturing angle, and the capturing position of the light-field camera 100 when the light-field camera 100 captures each image.

In at least one exemplary embodiment, the three-dimensional image has a function of a map such as a navigation function. That is, the three-dimensional image having the function of the map is not obtained by drawing, but obtained by composting the number of images captured by the light-field camera 100.

At block S204, the character recognizing module 14 can recognize characters from each of the number of images. The character recognizing module 14 can convert the characters recognized in each of the number of images into an individual editable text. The character recognizing module 14 can store the number of images and each individual editable text into the storage device 20. The character recognizing module 14 can establish a relationship between each individual editable text and the corresponding image. In at least one exemplary embodiment, the character recognizing module 14 can recognize characters using optical character recognition (OCR) technology. In at least one exemplary embodiment, when no characters can be recognized from the image, the character recognizing module 14 can use a predetermined tag to indicate no editable text corresponding to the image. In at least one exemplary embodiment, the predetermined tag can be a word such as “EMPTY”. The character recognizing module 14 can further add the predetermined tag to an exchangeable image file format (Exif) of the image.

At block 5205, the image recognizing module 15 can determine whether one of the number of images matches a specific image. In at least one exemplary embodiment, the specific image can be an image downloaded from the internet, or an image that is input by a user. In at least one exemplary embodiment, when one of the number of images is determined to match the specific image, the image recognizing module 15 can obtain the one of the number of images from the storage device 20, and can display the one of the number of images on the light-field camera 100.

In at least one exemplary embodiment, when an object included in the one of the number of images matches an object included in the specific image, the image recognizing module 15 can determine the one of the number of images matches the specific image. In at least one exemplary embodiment, the image recognizing module 15 can determine whether the object included in the one of the number of images matches the object included in the specific image using a scale scale-invariant feature transform (SIFT) algorithm, or a speed-up robust features (SURF) algorithm. In other exemplary embodiments, when the object included in the one of the number of images matches the object included in the specific image, and characters included in the one of the number of images matches the characters included in the specific image, the image recognizing module 15 can determine the one of the number of images matches the specific image.

When one of the number of images matches the specific image, the image recognizing module 15 can determine a position of the specific image in the three-dimensional image according to a capturing position of the specific image. The image recognizing module 15 can further mark the position of the specific image in the three-dimensional image.

In other exemplary embodiments, when the capturing position of one of the number of images matches the capturing position of the specific image, the image recognizing module 15 can determine that the one of the number of images matches the specific image. In at least one exemplary embodiment, when a distance between the capturing position of the specific image and the capturing position of the one of the number of images is less than a predetermined distance value (e.g., 0.2 meter), the image recognizing module 15 can determine that the capturing position of the one of the number of images matches the capturing position of the specific image. The image recognizing module 15 can further mark the capturing position of the specific image in the three-dimensional image.

The controlling module 11 can further control the communication device 40 to send the number of images captured by the light-field camera 100 to other light-field cameras or a remote server (not indicated in FIG. 1). In at least one exemplary embodiment, a number of light-field cameras 100 can communicate with the remote server. Each of the number of light-field cameras 100 can transmit images captured by the same and transmit capturing parameters of each image to the remote server. The remote server 1 can composite the images transmitted from the number of light-field cameras 100 to form a three-dimensional image according to the capturing parameters of each image.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims.

What is claimed is:

1. A method for controlling a light-field camera, the method comprising:
controlling the light-field camera to capture a plurality of images;
obtaining capturing parameters of the light-field camera when the light-field camera captures each of the plurality of images; and
compositing the plurality of images to form a three-dimensional image according to the capturing parameters.

2. The method according to claim 1, wherein the capturing parameters comprise a capturing orientation of the light-field camera, a capturing angle of the light-field camera, and a capturing position of the light-field camera.

3. The method according to claim 1, further comprising:
recognizing characters from each of the plurality of images;
converting the recognized characters from each of the plurality of images into an individual editable text; and
establishing a relationship between each individual editable text and the corresponding image.

4. The method according to claim 1, further comprising:
determining whether one of the plurality of images matches a specific image; and
marking a position of the specific image in the three-dimensional image according to a capturing position of the specific image, when one of the plurality of images matches the specific image.

5. The method according to claim 4, wherein when an object included in the one of the plurality of images matches an object included in the specific image, the one of the plurality of images is determined to match the specific image.

6. The method according to claim 4, wherein when a capturing position of one of the plurality of images matches the capturing position of the specific image, the one of the plurality of images is determined to match the specific image.

7. A light-field camera comprising:
at least one processor; and
a storage device storing one or more programs, when the one or more programs being executed by the at least one processor, cause the at least one processor to;
control the light-field camera to capture a plurality of images;
obtain capturing parameters of the light-field camera when the light-field camera capturing each of the plurality of images; and
composite the plurality of images to form a three-dimensional image according to the capturing parameters.

8. The light-field camera according to claim 7, wherein the capturing parameters comprise a capturing orientation of the light-field camera, a capturing angle of the light-field camera, and a capturing position of the light-field camera.

9. The light-field camera according to claim 7, wherein the at least one processor is further caused to:
recognize characters from each of the plurality of images;
convert the recognized characters from each of the plurality of images into an individual editable text; and
establish a relationship between each individual editable text and the corresponding image.

10. The light-field camera according to claim 7, wherein the at least one processor is further caused to:
determine whether one of the number of images matches a specific image; and
mark a position of the specific image in the three-dimensional image according to a capturing position of the specific image, when one of the plurality of images matches the specific image.

11. The method according to claim 10, wherein when an object included in the one of the number of images matches an object included in the specific image, the one of the number of images is determined to match the specific image.

12. The method according to claim 10, wherein when a capturing position of one of the number of images matches the capturing position of the specific image, the one of the number of images is determined to match the specific image.

13. A non-transitory storage medium having stored thereon instructions, when executed by a processor of a light-field camera, causing the processor to perform a method for controlling the light-field camera, wherein the method comprising:
controlling the light-field camera to capture a plurality of images;
obtaining capturing parameters of the light-field camera when the light-field camera capturing each of the plurality of images; and
compositing the plurality of images to form a three-dimensional image according to the capturing parameters.

14. The non-transitory storage medium according to claim 13, wherein the capturing parameters comprise a capturing orientation of the light-field camera, a capturing angle of the light-field camera, and a capturing position of the light-field camera.

15. The non-transitory storage medium according to claim 13, wherein the method further comprises:
recognizing characters from each of the plurality of images;
converting the recognized characters from each of the plurality of images into an individual editable text; and
establishing a relationship between each individual editable text and the corresponding image.

16. The non-transitory storage medium according to claim 13, wherein the method further comprises:
determining whether one of the plurality of images matches a specific image; and
marking a position of the specific image in the three-dimensional image according to a capturing position of the specific image, when one of the plurality of images matches the specific image.

17. The non-transitory storage medium according to claim 16, wherein when an object included in the one of the plurality of images matches an object included in the specific image, the one of the plurality of images is determined to match the specific image.

18. The non-transitory storage medium according to claim 16, wherein when a capturing position of one of the plurality of images matches the capturing position of the specific image, the one of the plurality of images is determined to match the specific image.
